(19) United States
(12) Patent Application Publication
(10) Pub. No.: US 2010/0095573 A1
(43) Pub. Date: Apr. 22, 2010

(54) Wearable And Attachable Device For Making And Displaying Lists

(76) Inventor: Wayne Lifshitz, KENSINGTON, MD (US)

Correspondence Address: KELLEY DRYE & WARREN LLP, 3050 K STREET, NW, SUITE 400, WASHINGTON, DC, 20007, US

(21) Appl. No.: 12/271,520

(22) Filed: Nov. 14, 2008

Related U.S. Application Data
(60) Provisional application No. 61/106,345, filed on Oct. 17, 2008.

(51) Int. Cl. G09F 3/00; G09F 3/08; A45F 5/00

(52) U.S. Cl. 40/662; 40/299.01; 224/267

(57) ABSTRACT

The wearable and attachable device for making and displaying lists provides a writing surface for making lists that can be temporarily and repeatedly posted in the house or workplace and then worn on the user's wrist or around their neck while shopping. Embodiments of the invention are intended to provide the user with a conveniently placed rewriteable writing surface to develop lists, and is also intended to be worn by the user around the wrist or neck to provide the user with a quick and convenient reference to the written information while shopping. The wearable and attachable device for making and displaying lists may use versatile materials and the latest technology to provide a reusable surface for writing and conveniently displaying lists.

### FIELD OF THE INVENTION

The present invention relates to a device that can be posted around the house or office to provide a convenient writing surface to create lists and can also be worn around the wrist or neck of a person.

### BACKGROUND OF THE INVENTION

There is a need for a device that provides a convenient writing surface to create lists and further permits the user to wear the device around their wrist or neck when the user needs to be reminded of, refer to, or update the list. The need for this device is acute for people who generally make written lists, like a shopping list, and peruse the shopping aisles with a list and pencil in one hand while pushing a cart or carrying a basket with the other, thereby making shopping inconvenient by not having a hand free to select items from the shelf. Sometimes items tend to get inadvertently omitted from these lists, as the lists are compiled in a hurry a few minutes before heading out to the store. Sometimes the lists get misplaced, either because they cannot be located while going out to shop, or one does not remember whether the lists were left at home, in the car, in the pocket of a trouser or jacket not worn, or among the aisles in a shop. Therefore, compiling, maintaining such lists, and ensuring that they are conveniently available at the time of leaving to shop and while shopping is tedious and inconvenient.

Devices for making lists have been disclosed in various U.S. patents. U.S. Pat. No. 6,250,006 issued to Berrier relates to a magnetic pad for making lists. The Berrier device, however, is not portable enough to allow the user to wear the device on their wrist or conveniently carry it around the user's neck. U.S. Pat. No. 5,311,689 issued to Lindsey and U.S. Pat. No. 5,531,481 issued to Wiltshire disclose personal note-taking devices, which can be worn on the wrist. These devices, however, are for wearing on the wrist and cannot be posted at a convenient place in the house for the user to compile a list. The prior art includes other disclosures regarding note-taking devices, some of which require a paper note-taking mechanism, while others are personal note-taking devices. Although various display devices for taking notes exist in the prior art, none relate to a note-taking device adapted to be temporarily and repeatedly affixed to a flat surface for note taking, which can also be worn and carried around by the user.

One or more embodiment of the present invention fill the need for a device which can be posted around the house or office to provide a writing surface to create lists and can also be worn around the wrist or neck of a person. Various embodiments of the present invention also overcome shortcomings of the prior art because they provide devices for making personal lists, such as a shopping list, which may then be worn by the user on their wrist or around their neck. In various embodiments of the invention, one surface of the list may be magnetic, and, for example, temporarily attached to a refrigerator or other appliances to allow the user to make a list at their convenience. Various embodiments of the invention may also be attached to a customized countertop stand or any other flat surface for convenient access. Such a portable list may then be worn by the user on their wrist or around their neck while shopping, thereby freeing both hands for convenient and hassle-free shopping. After each use the user may wipe the writing surface clean for future uses, thereby creating a convenient reusable device for making and using lists.

### SUMMARY OF THE INVENTION

Responsive to the foregoing challenges, Applicant has developed an innovative wearable and attachable device for making and displaying lists, the device comprising: a substantially planar and flexible member having a first side, a second side, and two end portions; the first side of the substantially planar and flexible member being adapted to be writable upon and erasable; the second side of the substantially planar and flexible member being adapted to removably attach the device to a substantially planar surface; and the end portions of the substantially planar and flexible member being adapted to releasably and adjustably secure each other together.

Applicant has further developed an innovative wearable and attachable device for making and displaying lists, the device comprising: a substantially planar and flexible member having a first side, a second side, and two end portions; a detachable writing surface, the detachable writing surface being adapted to be removably attached to the first side of the substantially planar and flexible member; the second side of the substantially planar and flexible member being adapted to removably attach the device to a substantially planar surface; and the end portions of the substantially planar and flexible member being adapted to releasably and adjustably secure each other together.

Applicant has still further developed an innovative wearable and attachable device for making and displaying lists, the device comprising: a substantially planar and flexible member having a first side, a second side, and two end portions; the first side of the substantially planar and flexible member being adapted to be writable upon and erasable; the second side of the substantially planar and flexible member being adapted to removably attach the device to a substantially planar surface; and one of the end portions of the substantially planar and flexible member containing a pass-through hole.

Applicant has still further developed an innovative wearable and attachable device for making and displaying lists, the device comprising: a substantially planar and flexible member having a first side, a second side, and two end portions; the first side of the substantially planar and flexible member being adapted to be writable upon and erasable; means for removably attaching the device to a substantially planar surface; and means for releasably and adjustably securing the end portions of the substantially planar and flexible member together.

It is to be understood that both the foregoing general description and the following detailed description are exemplary and explanatory only, and are not restrictive of the invention as claimed. The accompanying drawings, which are incorporated herein by reference, and which constitute a part of this specification, illustrate certain embodiments of the invention and, together with the detailed description, serve to explain the principles of the present invention.

### BRIEF DESCRIPTION OF THE DRAWINGS

In order to assist the understanding of this invention, reference will now be made to the appended drawings, in which like reference characters refer to like elements.

FIG. 1 is a side view of an exemplary embodiment of a wearable and attachable device for making and displaying lists.

FIG. 2 is a rear plan view showing a magnetic surface and outer edges of an exemplary device of FIG. 1.

FIG. 3 is a top plan view showing a message receiving surface and outer edges of an exemplary device of FIG. 1.

FIG. 4 is a top plan view of another exemplary embodiment of a wearable and attachable device for making and displaying lists.

FIG. 5 is a top plan view of yet another exemplary embodiment of a wearable and attachable device for making and displaying lists showing a message receiving surface with indicia printed upon the message receiving surface.

FIG. 6 is a top plan view of yet another exemplary embodiment of a wearable and attachable device for making and displaying lists showing a message receiving surface with indicia printed upon the message receiving surface.

FIG. 7 illustrates the use of yet another exemplary embodiment of a wearable and attachable device for making and displaying lists. The illustrations show: the list being attached to a vertical surface, such as a refrigerator or a countertop stand for the user to write upon and compile a list; the device being worn by the user; and the device being written upon or updated while being worn by the user.

FIG. 8 is a top plan view of another exemplary embodiment of a wearable and attachable device for making and displaying lists.

### DETAILED DESCRIPTION OF EMBODIMENTS

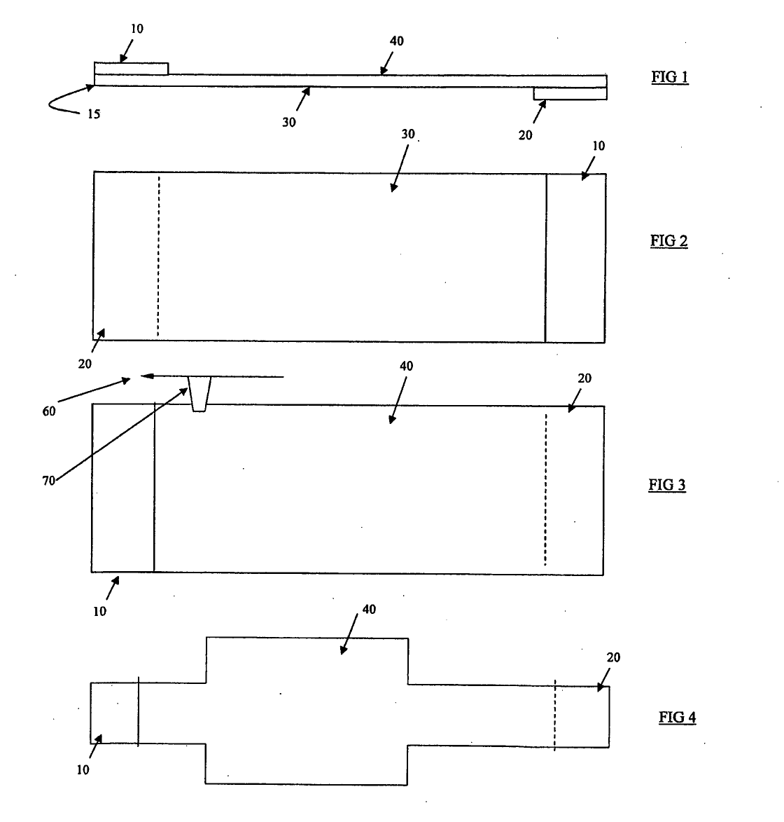

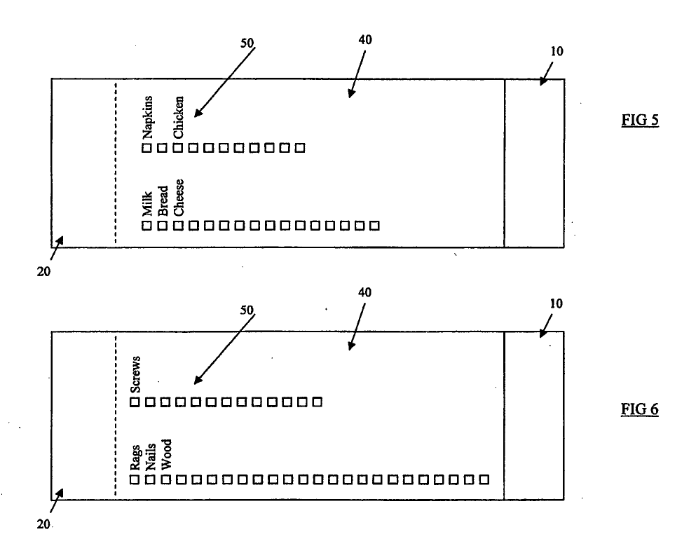

The wearable and attachable device for making and displaying lists may allow the users to make lists, such as a shopping list, while the invention is attached to a substantially planar surface, such as a refrigerator or a countertop stand and then may enable the user to transport the list to a remote shopping destination while being worn around the user's wrist or neck. This functionality allows the user to free both hands while shopping and at the same time maintain an accurate check on the items to shop for. Reference will now be made in detail to a first embodiment of the present invention, an example of which is illustrated in the accompanying drawings. FIGS. 1, 2 and 3 show an embodiment of the wearable and attachable device for making and displaying lists. FIG. 1 is a side view of the exemplary embodiment, while FIGS. 2 and 3 are rear plan view and top plan view, respectively, of an exemplary embodiment of the wearable and attachable device for making and displaying lists. FIG. 1 shows a substantially planar and flexible member 15, the substantially planar and flexible member having a first side 40 and a second side 30. The end portions of the device may comprise fastening or securing means 10 and 20. The end portions of the wearable and attachable device for making and displaying lists 10 and 20 may be secured together with any closure means from the closures presently available in the marketplace.

The first side of the substantially planar and flexible member 40 may be writable upon. The first side of the substantially planar and flexible member 40 may also be erasable. The first side of the substantially planar and flexible member 40 may be smooth and non-porous so that a wet erase marker can be used to write on it. The first side of the substantially planar and flexible member 40 may be designed such that it can be written upon by, one or more of, pencil, wet erase marker, dry erase marker, china marker and wax marker. As shown in FIG. 3, a writing means 60 may be removably attached to the first side of the substantially planar and flexible member 40 using an attaching means 70. The first side of the substantially planar and flexible member 40 may be designed such that a detachable writing surface can be removably attached to it. The first side of the substantially planar and flexible member 40 may be designed such that the writing upon it can be erased by, one or more of, tissue, damp tissue, towel, eraser and soapy solvent. The first side of the substantially planar and flexible member 40 may have a cover. The cover may be transparent and it may be removably attached to the first side of the substantially planar and flexible member 40. The cover may prevent the writing surface from getting dirty and from smudging.

The second side of the substantially planar and flexible member 30 may be adapted to removably attach the wearable and attachable device for making and displaying lists to other substantially planar surfaces. The second side of the substantially planar and flexible member 30 may be magnetic attached to any metallic surface, such as a refrigerator or a countertop stand. The second side of the substantially planar and flexible member 30 may be non-magnetic and may use presently available reusable attaching means, such as Velcro, glue or adhesive to removably attach the wearable and attachable device for making and displaying lists to other substantially planar surfaces.

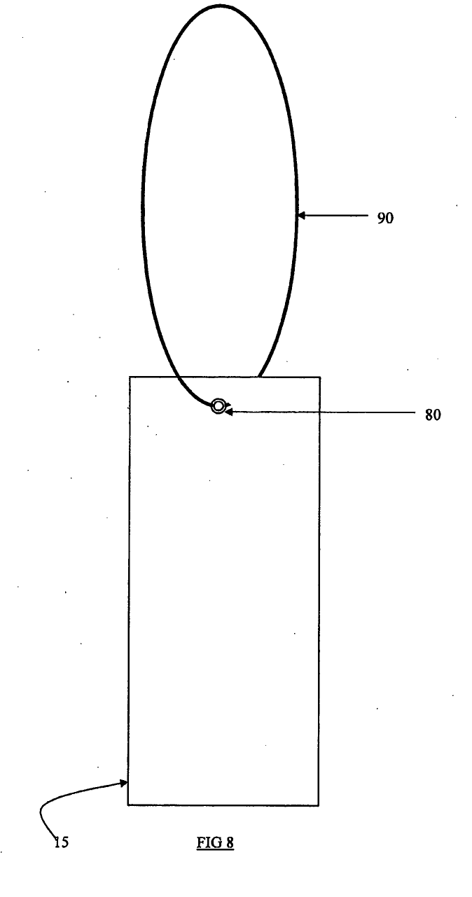

FIG. 7 illustrates the use of yet another exemplary embodiment of a wearable and attachable device for making and displaying lists. FIG. 7 shows the second side of the substantially planar and flexible member 30 may be attached to a countertop stand. The second side of the substantially planar and flexible member 30 may also be magnetically attached to a refrigerator or other metallic surfaces. In this position the invention may lie flat on the refrigerator surface or the countertop holder surface and provide a conveniently located and readily accessible writing surface to compile lists. FIG. 7 further shows the wearable and attachable device for making and displaying lists may be designed so that it can be fastened around the user's wrist by the two free ends 10 and 20 by, one or more of, magnets, snap bracelets, snap fasteners, hook and loop fasteners, panel fasteners, adhesive, buckles, links, screws, rivets, retaining rings, pins, clinch studs, bolts, anchors, clips, buttons, zippers, ties and Velcro. The wearable and attachable device for making and displaying lists may be adjustable to the wrist size of the user. In this position, the wearable and attachable device for making and displaying lists may be transported to the shopping destination while being worn around the user's wrist. This functionality allows the user to free both hands while shopping and maintain an accurate check on the items to shop for. FIG. 7 further illustrates that the wearable and attachable device for making and displaying lists may be written upon to update or check-off the list using any one of the disclosed writing means 60. After each use, the user may wipe the writing surface 40 clean for additional uses.

FIG. 8 shows another embodiment of the wearable and attachable device for making and displaying lists. FIGS. 8 is a top plan view of an exemplary embodiment of a wearable and attachable device for making and displaying lists. The wearable and attachable device for making and displaying lists may have a small hole 80 in either of the end portions 10 or 20, located near the edge of the substantially planar and flexible member 15. The lanyard 90 may pass through the hole 80 and around the neck of the user to removably attach the wearable and attachable device for making and displaying lists around the neck of the user. In this position, the wearable and attachable device for making and displaying lists may be transported to the shopping destination while being worn around the user's neck. The wearable and attachable device for making and displaying lists may be worn around the neck using a lanyard 90, strap, rope, cord or any other similar device. The wearable and attachable device for making and displaying lists may be designed with both means for hanging the device around the neck and means for wearing the device around the wrist. In this configuration, the user may choose to either wear wearable and attachable device for making and displaying lists around the neck or fastened it around their wrist.

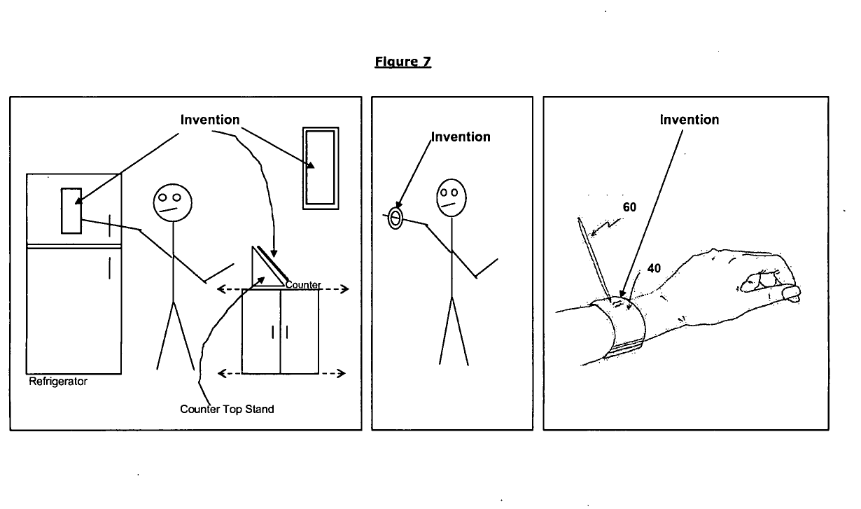

FIGS. 5 and 6 show another embodiment of the first side of the substantially planar and flexible member 40 containing numerous sets of indicia 50 permanently imprinted thereon. Each set of indicia 50 may describe a household item or may contain blank spaces allowing the user to write additional items. Each indicia may have a blank box adjacent to it to enable the user to check items off their lists.

FIG. 4 shows another embodiment of the wearable and attachable device for making and displaying lists. FIG. 4 is a top plan view of an exemplary embodiment of a wearable and attachable device for making and displaying lists. The wearable and attachable device for making and displaying lists may be generally rectangular in shape. As shown in FIG. 4, some sections of the wearable and attachable device for making and displaying lists may have different widths or may be wider in some sections than others.

With regard to all embodiments, the members 15, 10 and 20 may have various shapes, sizes, colors and orientations without departing from the intended scope of the present invention. The members 15, 10 and 20 can be manufactured from a host of modern day materials including, but not limited to, plastics and non-porous dry erase. The substantially planar and flexible member 15 may be made of flexible material so that it can wrap around the wrist of a user. The substantially planar and flexible member 15 may be rectangular in general dimension. The members 15, 10 and 20 may be constructed without any sharp edges to prevent injury to or discomfort to the user of the wearable and attachable device for making and displaying lists. The second side of the substantially planar and flexible member 30 may be covered with a soft material, like cotton, felt, or any other fabric to make the device comfortable for wearing.

It will be apparent to those skilled in the art that variations and modifications of the present invention can be made without departing from the scope or spirit of the invention. For example, size, shape and materials may be changed without departing from the intended scope of the invention and appended claims. It is further appreciated that forming one or more elements of the apparatus embodiments of the present invention integrally, as opposed to separately, is intended to fall within the scope of the invention and appended claims.

What is claimed is:

1. A wearable and attachable device for making and displaying lists, the device comprising:
a substantially planar and flexible member having a first side, a second side, and two end portions;
the first side of the substantially planar and flexible member being adapted to be writable upon and erasable;
the second side of the substantially planar and flexible member being adapted to removably attach the device to a substantially planar surface; and
the end portions of the substantially planar and flexible member being adapted to releasably and adjustably secure each other together.

2. The device of claim 1, wherein the second side of the substantially planar and flexible member is adapted to magnetically attach to the substantially planar surface.

3. The device of claim 1, wherein the second side of the substantially planar and flexible member is adapted to magnetically attach to an outer surface of a refrigerator.

4. The device of claim 1, wherein the second side of the substantially planar and flexible member is covered with a soft fabric.

5. The device of claim 1, wherein one of the end portions of the substantially planar and flexible member contains a pass-through hole.

6. The device of claim 1, wherein the end portions of the substantially planar and flexible member are releasably and adjustably secured by one or more fasteners selected from the group consisting of magnet, snap bracelet, snap fastener, hook and loop fastener, panel fastener, adhesive, buckle, link, screw, rivet, retaining ring, pin, clinch stud, bolt, anchor, clip, button, zipper, tie and Velcro.

7. The device of claim 6, wherein the end portions of the substantially planar and flexible member are adapted to releasably and adjustably secure each other around a wrist of an user.

8. The device of claim 1, wherein the first side of the substantially planar and flexible member is adapted to be written upon by writing instruments selected from the group consisting of pencil, wet erase marker, dry erase marker, china marker and wax marker.

9. The device of claim 1, wherein the first side of the substantially planar and flexible member is adapted to be erased by an erasing instrument selected from a group consisting of tissue, damp tissue, towel, eraser and soapy solvent.

10. The device of claim 1, further comprising a cover attached to the first side of the substantially planar and flexible member.

11. The device of claim 10, wherein the cover is transparent.

12. The device of claim 10, wherein the cover is removably attached.

13. The device of claim 1, wherein the first side of the substantially planar and flexible member further having numerous sets of permanently imprinted indicia.

14. A wearable and attachable device for making and displaying lists, the device comprising:
a substantially planar and flexible member having a first side, a second side, and two end portions;
a detachable writing surface, the detachable writing surface being adapted to be removably attached to the first side of the substantially planar and flexible member;
the second side of the substantially planar and flexible member being adapted to removably attach the device to a substantially planar surface; and
the end portions of the substantially planar and flexible member being adapted to releasably and adjustably secure each other together.

15. The device of claim 14, wherein the second side of the substantially planar and flexible member is adapted to magnetically attach to the substantially planar surface.

16. The device of claim 14, wherein the second side of the substantially planar and flexible member is adapted to magnetically attach to an outer surface of a refrigerator.

17. The device of claim 14, wherein the second side of the substantially planar and flexible member is covered with a soft fabric.

18. The device of claim 14, wherein one of the end portions of the substantially planar and flexible member contains a pass-through hole.

19. The device of claim 14, wherein the end portions of the substantially planar and flexible member are releasably and adjustably secured by one or more fasteners selected from the group consisting of magnet, snap bracelet, snap fastener, hook and loop fastener, panel fastener, adhesive, buckle, link, screw, rivet, retaining ring, pin, clinch stud, bolt, anchor, clip, button, zipper, tie and Velcro.

20. The device of claim 19, wherein the end portions of the substantially planar and flexible member are adapted to releasably and adjustably secure each other around a wrist of an user.

21. The device of claim 14, wherein the detachable writing surface is adapted to be written upon by writing instruments selected from the group consisting of pencil, wet erase marker, dry erase marker, china marker and wax marker.

22. The device of claim 14, wherein the detachable writing surface is adapted to be erased by an erasing instrument selected from a group consisting of tissue, damp tissue, towel, eraser and soapy solvent.

23. The device of claim 14, further comprising a cover attached to the first side of the substantially planar and flexible member.

24. The device of claim 25, wherein the cover is transparent.

25. The device of claim 25, wherein the cover is removably attached.

26. The device of claim 14, wherein the detachable writing surface further having numerous sets of permanently imprinted indicia.

27. A wearable and attachable device for making and displaying lists, the device comprising:
a substantially planar and flexible member having a first side, a second side, and two end portions;
the first side of the substantially planar and flexible member being adapted to be writable upon and erasable;
the second side of the substantially planar and flexible member being adapted to removably attach the device to a substantially planar surface; and
one of the end portions of the substantially planar and flexible member containing a pass-through hole.

28. The device of claim 27, wherein the second side of the substantially planar and flexible member is adapted to magnetically attach to the substantially planar surface.

29. The device of claim 27, wherein the second side of the substantially planar and flexible member is adapted to magnetically attach to an outer surface of a refrigerator.

30. The device of claim 27, wherein the second side of the substantially planar and flexible member is covered with a soft fabric.

31. The device of claim 27, wherein the end portions of the substantially planar and flexible member are adapted to releasably and adjustably secure each other together.

32. The device of claim 31, wherein the end portions of the substantially planar and flexible member are releasably and adjustably secured by one or more fasteners selected from the group consisting of magnet, snap bracelet, snap fastener, hook and loop fastener, panel fastener, adhesive, buckle, link, screw, rivet, retaining ring, pin, clinch stud, bolt, anchor, clip, button, zipper, tie and Velcro.

33. The device of claim 32, wherein the end portions of the substantially planar and flexible member are adapted to releasably and adjustably secure each other around a wrist of an user.

34. The device of claim 27, wherein the first side of the substantially planar and flexible member is adapted to be written upon by writing instruments selected from the group consisting of pencil, wet erase marker, dry erase marker, china marker and wax marker.

35. The device of claim 27, wherein the first side of the substantially planar and flexible member is adapted to be erased by an erasing instrument selected from a group consisting of tissue, damp tissue, towel, eraser and soapy solvent.

36. The device of claim 27, further comprising a cover attached to the first side of the substantially planar and flexible member.

37. The device of claim 36, wherein the cover is transparent.

38. The device of claim 36, wherein the cover is removably attached.

39. The device of claim 27, wherein the first side of the substantially planar and flexible member further having numerous sets of permanently imprinted indicia.

40. A wearable and attachable device for making and displaying lists, the device comprising:
a substantially planar and flexible member having a first side, a second side, and two end portions;
the first side of the substantially planar and flexible member being adapted to be writable upon and erasable;
means for removably attaching the device to a substantially planar surface; and
means for releasably and adjustably securing the end portions of the substantially planar and flexible member together.
